(19) United States
(12) Patent Application Publication
(10) Pub. No.: US 2025/0211993 A1
(43) Pub. Date: Jun. 26, 2025

(54) Integrity Of MAC Header And Data With Relaxed Receiver Requirement In Wireless Communications

(71) Applicant: MediaTek Inc., Hsinchu City (TW)

(72) Inventors: Li-Hsiang Sun, San Jose, CA (US); Gabor Bajko, San Jose, CA (US); Chien-Fang Hsu, Hsinchu City (TW); James Chih-Shi Yee, San Jose, CA (US); Yonggang Fang, San Jose, CA (US); Kai Ying Lu, San Jose, CA (US)

(21) Appl. No.: 18/984,674

(22) Filed: Dec. 17, 2024

Related U.S. Application Data
(60) Provisional application No. 63/613,178, filed on Dec. 21, 2023.
(60) Provisional application No. 63/548,893, filed on Feb. 2, 2024.
(60) Provisional application No. 63/561,372, filed on Mar. 5, 2024.

(51) Int. Cl. H04W 12/128; H04L 5/00; H04L 69/22

(52) U.S. Cl. CPC H04W 12/128; H04L 5/0055; H04L 69/22

(57) ABSTRACT

Techniques pertaining to protecting integrity of medium access control (MAC) header and data with relaxed receiver requirement in wireless communications are described. An apparatus (e.g., a station (STA)) transmits one or more MAC protocol data units (MPDUs). The apparatus then receives a protected acknowledgement. The apparatus detects a man in the middle (MITM) attack based on a time synchronization function (TSF) or signature in the protected acknowledgement.

### CROSS REFERENCE TO RELATED PATENT APPLICATION

The present disclosure is part of a non-provisional patent application claiming the priority benefit of U.S. Provisional Patent Application Nos. 63/613,178, 63/548,893 and 63/561,372, filed 21 Dec. 2023, 2 Feb. 2024 and 5 Mar. 2024, respectively, the contents of which herein being incorporated by reference in their entirety.

### TECHNICAL FIELD

The present disclosure is generally related to wireless communications and, more particularly, to protecting integrity of medium access control (MAC) header and data with relaxed receiver requirement in wireless communications.

### BACKGROUND

Unless otherwise indicated herein, approaches described in this section are not prior art to the claims listed below and are not admitted as prior art by inclusion in this section.

In wireless communications such as Wi-Fi (or WiFi) under the Institute of Electrical and Electronics Engineers (IEEE) 802.11 specifications, to protect the integrity of a frame or MAC protocol data unit (MPDU), it has been proposed that a message integrity check (MIC) be utilized in the MAC header and another MIC be utilized in the data. The reason that a separate header MIC is proposed in addition to the data MIC for data is that the data may need to be retransmitted and, in such cases, recalculation of the data MIC of the data would not be needed (as it remains the same) while only the header MIC of the MAC header is recalculated. Thus, a new MIC is generated for the header fields each time an MPDU is (re)transmitted. It is generally assumed that the recipient of unicast data/management frames would only verify the header MIC before sending an acknowledgement (ACK) or block acknowledgement (BlockAck or BA) because verifying the data MIC requires more time and data MIC check is typically not performed by hardware. However, some considerations need to be taken into account on the receiver side for MIC verification before sending an ACK or BA. For instance, the recipient may have processing/cost constraints and/or performance degradation for processing all the header MICs received in a high-rate aggregation-MPDU (AMPDU) before sending immediate ACK/BA. For instance, it would be computationally intensive and time consuming for the recipient to check the MIC of each data frame when there are many MPDUs in the AMPDU. Moreover, extra padding and/or delimiters for extra time for header MIC processing in an AMPDU tends to reduce throughput, and header MIC check does not guarantee data integrity. Lastly but not least, in view of aforementioned issues, the recipient is susceptible to an attack. For instance, for each data frame, in case the recipient only checks the frame check the header MIC and the frame check sequence (FCS) before sending ACK, it would still be possible for an attacker (e.g., man in the middle (MITM)) to send a fake or manipulated data portion of the frame with a correct FCS and a replayed MAC header.

Due to the above-described shortcomings (header MIC not protecting data integrity), there were proposals that would add a timestamp as an input for generating header MIC, called time-based header MIC. This minimizes the opportunity for a non-full-duplex attacker to perform the attack in the example of previous paragraph. However, the recipient now needs to perform one more check (whether time is correct for the soliciting frame) within a short duration before ACK. Therefore, there is a need for a solution of protecting the integrity of MAC header and data with relaxed receiver requirement in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods, and apparatuses pertaining to protecting the integrity of MAC header and data with relaxed receiver requirement in wireless communications. It is believed that various schemes proposed herein may address or otherwise alleviate these aforementioned issue(s). For instance, implementations of one or more of the proposed schemes may aid in reducing the processing time on the recipient/receiver side as well as preventing additional attack scenarios not preventable previously.

In one aspect, a method may involve an originator station (STA) transmitting one or more MPDUs. The method may also involve the originator STA receiving a protected acknowledgement. The method may further involve the originator STA detecting an MITM attack based on a time synchronization function (TSF) or signature in the protected acknowledgement.

In another aspect, an apparatus may include a transceiver configured to communicate wirelessly and a processor coupled to the transceiver. The processor may transmit one or more MPDUs. The processor may also receive a protected acknowledgement. The processor may further detect an MITM attack based on a TSF or signature in the protected acknowledgement.

It is noteworthy that, although the description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various schemes in accordance with the present disclosure may be implemented.

FIG. 2 is a diagram of an example scenario in which various proposed schemes in accordance with the present disclosure may be implemented.

FIG. 3 is a diagram of an example scenario in which various proposed schemes in accordance with the present disclosure may be implemented.

FIG. 4 is a diagram of an example scenario in which various proposed schemes in accordance with the present disclosure may be implemented.

FIG. 5 is a diagram of an example scenario in which various proposed schemes in accordance with the present disclosure may be implemented.

FIG. 6 is a diagram of an example scenario in which various proposed schemes in accordance with the present disclosure may be implemented.

FIG. 7 is a diagram of an example scenario in which various proposed schemes in accordance with the present disclosure may be implemented.

FIG. 8 is a diagram of an example design under a proposed scheme in accordance with the present disclosure.

FIG. 9 is a block diagram of an example communication system under a proposed scheme in accordance with the present disclosure.

FIG. 10 is a flowchart of an example process under a proposed scheme in accordance with the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to protecting the integrity of MAC header and data with relaxed receiver requirement in wireless communications. According to the present disclosure, a number of possible solutions may be implemented separately or jointly. That is, although these possible solutions may be described below separately, two or more of these possible solutions may be implemented in one combination or another.

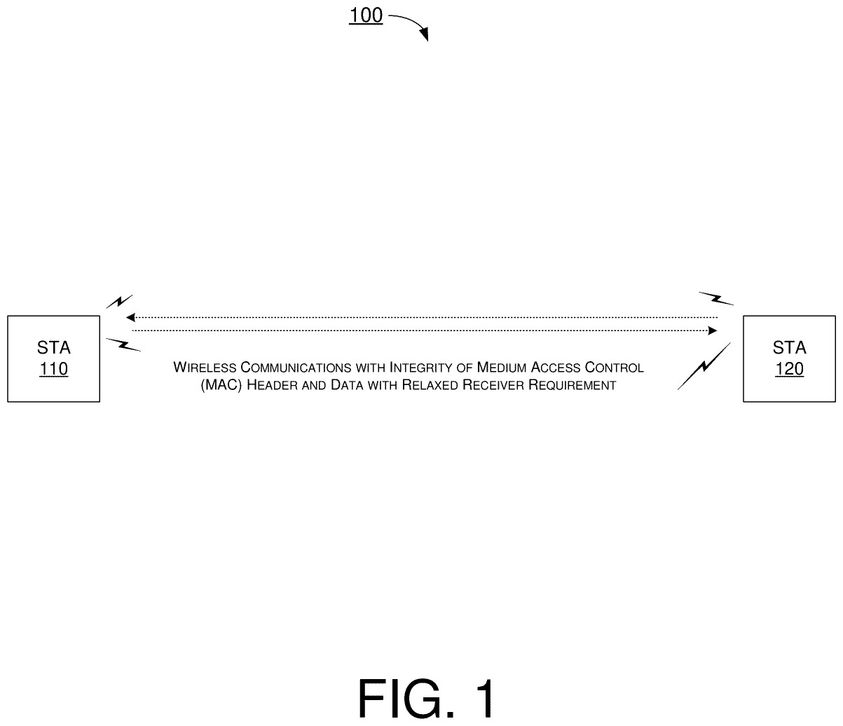

FIG. 1 illustrates an example network environment 100 in which various solutions and schemes in accordance with the present disclosure may be implemented. FIG. 1-FIG. 10 illustrate examples of implementation of various proposed schemes in network environment 100 in accordance with the present disclosure. The following description of various proposed schemes is provided with reference to FIG. 1-FIG. 10.

Referring to FIG. 1, network environment 100 may include at least a first STA (STA 110) and a second STA (STA 120). Either STA 110 or STA 120 may be an originator STA of a BlockAck session (herein interchangeably referred to as “originator”), and either STA 110 or STA 120 may be a recipient STA of a BlockAck session (herein interchangeably referred to as “Recipient”). While there may be additional STAs involved in network environment 100 under one or more schemes proposed herein, for simplicity only two STAs (STA 110 and STA 120) are shown in FIG. 1 with the understanding that additional STAs may be involved. Each of STA 110 and STA 120 may be configured to implement various proposed schemes in accordance with the present disclosure as described below. For instance, one of STA 110 and STA 120 may function as an originator of a BlockAck session and the other of STA 110 and STA 120 may function as a recipient of a BlockAck session in wireless communications under the proposed schemes. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Under various proposed schemes in accordance with the present disclosure, alternative approaches other than MIC check before sending an ACK may be undertaken. Under the proposed schemes, the recipient may not need to check the header MIC before sending a protected ACK and, conversely, the originator may check that the ACK is genuine and is solicited before removing correspondingly acknowledged PPDU(s) from its retransmission buffer and confirming an MAC state change. Accordingly, the burden of integrity checking may be at least partially shifted from the recipient to the originator. Unlike recipient who must perform header MIC verification before sending ACK, The originator has more time budget for integrity checking because it does not have a strict deadline. Under the proposed schemes, the originator may verify the MIC of the ACK even if the ACK is unsolicited (e.g., sent by an attacker). For instance, the originator may perform a replay check and, if the ACK is fresh, update its replay counter. Moreover, the originator may discard the ACK if it is unsolicited. Moreover, under the proposed schemes, to prevent the ACK from being replayed by an attacker at a later time, a timestamp, also known as timing synchronization function (TSF), or signature-protected ACK may be utilized. For instance, the originator may check the ACK with TSF/signature and MIC of the BlockAck frame before accepting the ACK. The TSF/signature may be included in the input parameters for the MIC of the ACK. Advantageously, potential consequences of an attack on both the recipient side and originator side may be prevented by implementing one or more of the proposed schemes.

Under a first proposed scheme in accordance with the present disclosure, attack scenarios may be prevented without a TSF or signature in the protected ACK. In such attack scenarios, the attacker may modify the data frame and may not replay an ACK. Moreover, the recipient may protect the ACK instead of checking the header MIC of a soliciting frame before sending the ACK.

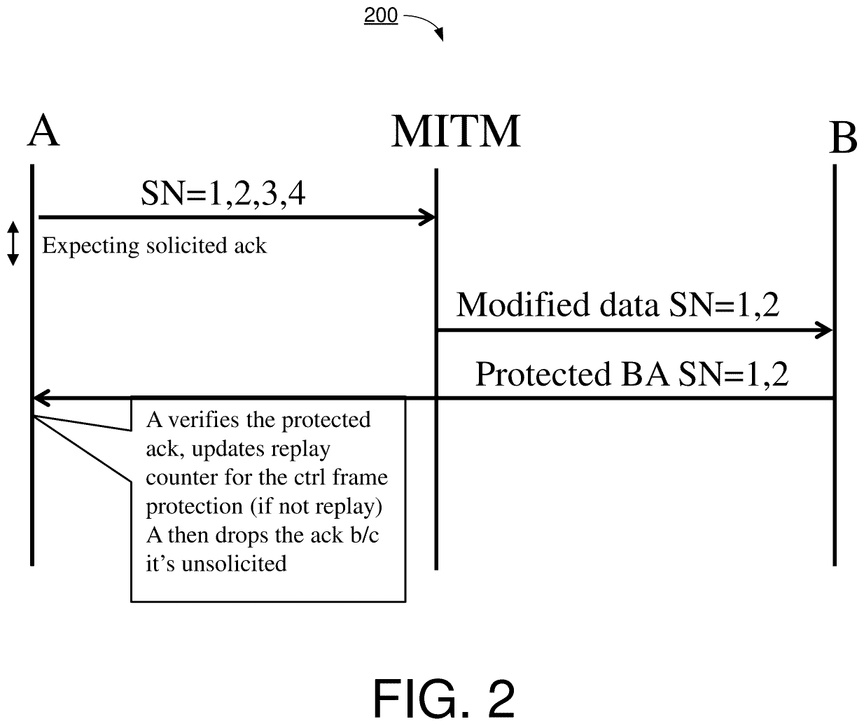

FIG. 2 illustrates an example scenario 200 in which various proposed schemes in accordance with the present disclosure may be implemented. Scenario 200 may pertain to prevention of an attack under the first proposed scheme. Referring to FIG. 2, after receiving MPDUs with sequence numbers (SNs) of SN=1, 2, 3, 4, respectively, from an originator A (e.g., STA 110) a non-full-duplex MITM attacker, which cannot receive and transmit simultaneously, may modify the MPDUs and then send some or all of the modified MPDUs (e.g., with modified data for SNs=1, 2) to a recipient B (e.g., STA 120) without making any header change in the modified MPDUs. Meanwhile, the originator A may be expecting to receive a solicited ACK from recipient B but eventually did not receive it within the window ACK is supposed to be sent. Upon receipt of the tempered data, the recipient B may send a protected BA regarding SNs=1, 2. Recipient B eventually drops the tempered data after sending the ack based on the failed data MIC check for SN=1,2. Upon receipt, the originator A may verify the protected BA and update its replay counter for the control frame protection (if no replay). Since the BA is unsolicited, the originator A may drop the BA. Accordingly, under the first proposed scheme, instead of the MITM attack being detected due to time-based header MIC check at the recipient side, the original A may detect the MITM attack by the unsolicited ACK, and the recipient eventually drops the tempered data

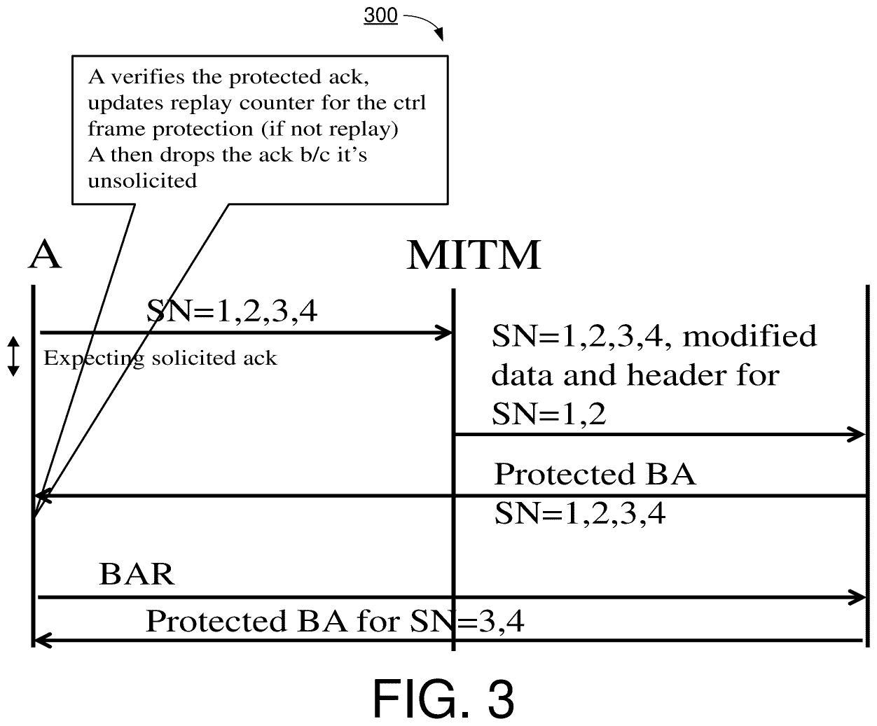

FIG. 3 illustrates an example scenario 300 in which various proposed schemes in accordance with the present disclosure may be implemented. Scenario 300 may pertain to prevention of an attack under the first proposed scheme. Referring to FIG. 3, upon receiving MPDUs with sequence numbers (SNs) of SN=1, 2, 3, 4, respectively, from an originator A (e.g., STA 110) an MITM attacker may modify the MPDUs and then send some or all of the modified MPDUs (e.g., with modification for SNs=1, 2) to a recipient B (e.g., STA 120) with changes made in both data and header for SNs=1, 2. Meanwhile, the originator A may be expecting to receive a solicited ACK from recipient B. Upon receipt, the recipient B may send a first protected ACK for SNs=1, 2, 3, 4, after performing FCS check only. Upon receiving the first protected ACK, the originator A may detect that the first protected ACK is an unsolicited ACK and, correspondingly, may not update its transmission buffer and MAC state. That is, the originator A may verify the first protected BA and update its replay counter for the control frame protection (if no replay). Since the first protected ACK is unsolicited, the originator A may drop the first protected ACK. The recipient B may also verify the header and data MICs of SNs=1, 2, 3, 4 and may determine that only SNs=3, 4 pass the check. After detecting the attack, the originator A may send a protected standalone block acknowledge request (BAR) to check the receiver status. Upon receiving the BAR, the recipient B may send a second protected ACK (or BA) for SNs=3, 4 if both MPDU's header and data MICs are verified. Upon receiving the second protected ACK (or BA), the originator A may verify it and remove SNs=3, 4 from its transmission buffer.

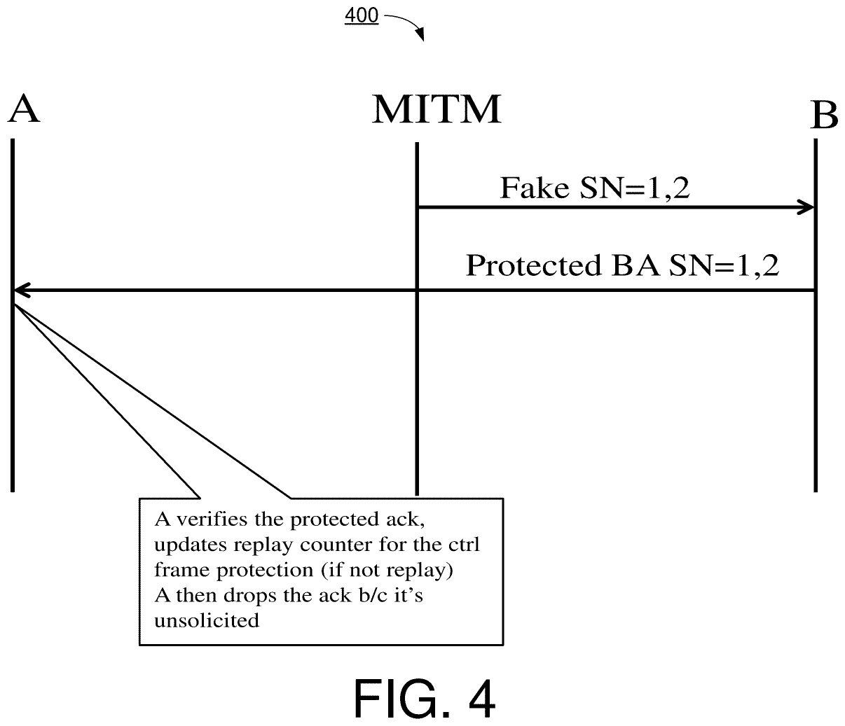

FIG. 4 illustrates an example scenario 400 in which various proposed schemes in accordance with the present disclosure may be implemented. Scenario 400 may pertain to prevention of an attack under the first proposed scheme. Referring to FIG. 4, an MITM may send fake header and data with SNs=1, 2 to a recipient B (e.g., STA 110). Upon receiving the fake data, the recipient B may send a protected BA for SNs=1, 2 to an originator A (e.g., STA 120). Upon receipt, the originator A may verify the protected BA and update its replay counter for the control frame protection (if no replay). Since the BA is unsolicited, the originator A may drop the BA. Accordingly, under the first proposed scheme, instead of the MITM attack being detected due to header MIC check at the recipient side, the original A may detect the MITM attack by the unsolicited BA. Recipient B eventually drops the faked MPDUs after sending the ack based on the failed header MIC check.

In view of the above, for the scenarios in which an ACK/BA is not replayed by the attacker/MITM and the attack is not in real-time, checking the header MIC at the recipient side before sending the ACK/BA may not provide additional protection versus the case when the header and data MIC is checked at the recipient side after sending a protected ACK/BA, assuming the protected ACK/BA is verified at the originator side before updating its transmission buffer and MAC layer states. The first proposed scheme may shift the freshness-checking burden to the originator side, which tends to be simpler to implement. The originator may not have a short interframe space (SIFS) deadline of MIC processing. The MIC check and follow-up actions may occur in parallel with the transmission of other MPDUs in the transmission opportunity (TXOP). The originator may verify only a single response frame from each recipient instead of recipient checking multiple/longer MPDUs before sending the single response (ACK). The recipient may not need to have a SIFS deadline for header MIC checking. The recipient may check header/data MIC after sending an ACK/BA, and the recipient may not change the state/action based on the MPDUs being yet to be verified.

Under a second proposed scheme in accordance with the present disclosure, attack scenarios may be prevented with a TSF or signature in the protected ACK. In such attack scenarios, the attacker may modify the data frame and jam the sender to prevent the sender from receiving the ACK. Alternatively, or additionally, the attacker may inject data frame(s) to repay ACK later. Alternatively, or additionally, the attacker may jam the sender to prevent the sender from receiving ACK, and the attacker may then jam the recipient to prevent the recipient from receiving any resent data with modified header and replay ACK. In some implementations, the header MIC may be used as the signature.

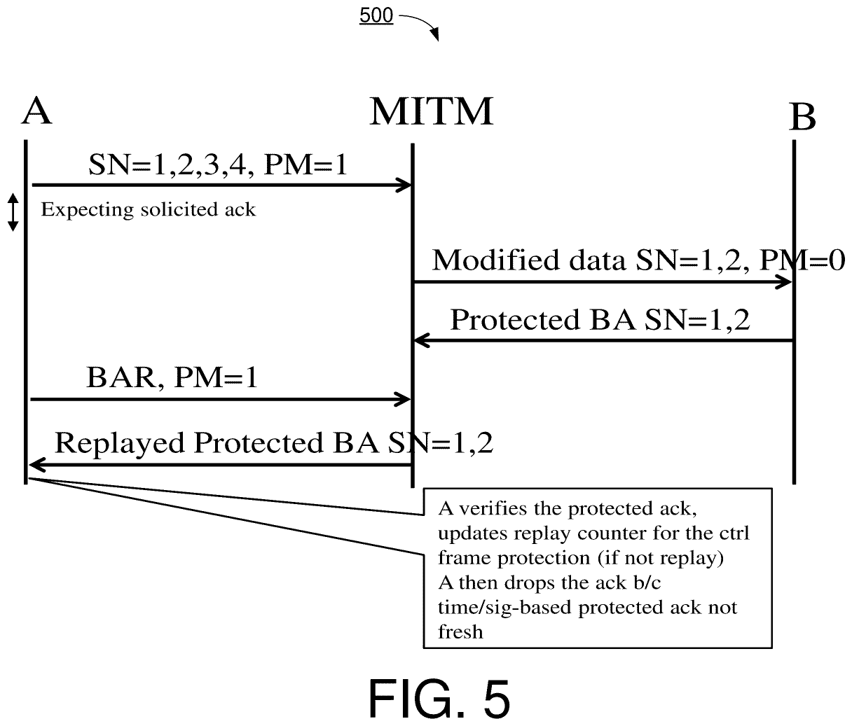

FIG. 5 illustrates an example scenario 500 in which various proposed schemes in accordance with the present disclosure may be implemented. Scenario 500 may pertain to prevention of an attack under the second proposed scheme. Referring to FIG. 5, upon receiving MPDUs with sequence numbers (SNs) of SN=1, 2, 3, 4, respectively, and with a power management (PM) bit set to 1 (e.g., PM=1) from an originator A (e.g., STA 110) an MITM attacker may modify the MPDUs and then send some or all of the modified MPDUs (e.g., with modification for SNs=1, 2) to a recipient B (e.g., STA 120) with changes made in both data and header for SNs=1, 2 and with PM=0. Meanwhile, the originator A may be expecting to receive a solicited ACK from recipient B. Upon receipt, the recipient B may send a protected BA with a TSF or signature for SNs=1, 2. Since the originator A has not received the expected solicited ACK from the recipient B, the originator A may send a BAR with PM=1. Upon receiving this BAR, the MITM may send a replayed protected BA for SNs=1, 2 to the originator A. Upon receipt, the originator A may verify the replayed protected BA and update its replay counter for the control frame protection (if no replay). Since the replayed protected BA is not considered fresh because TSF or signature does not match the soliciting BAR frame, the originator A may drop the replayed protected BA. Accordingly, under the second proposed scheme, instead of the MITM attack being detected due to time-based header MIC check at the recipient side, the original A may detect the MITM attack by the time/signature-based protected ACK/BA as the TSF or signature contained in the replayed protected BA does not correspond to or match information in the soliciting MPDUs.

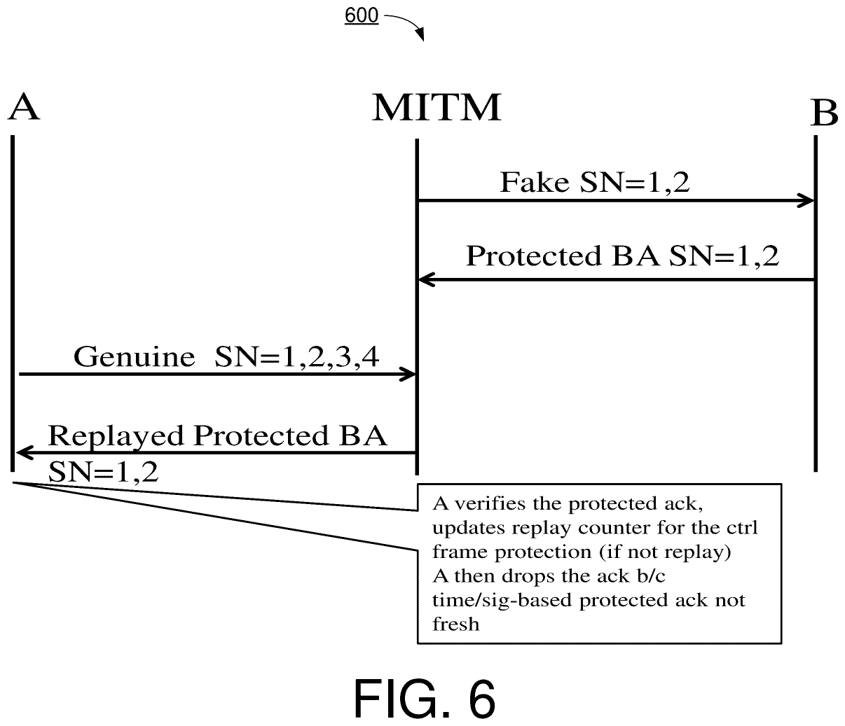

FIG. 6 illustrates an example scenario 600 in which various proposed schemes in accordance with the present disclosure may be implemented. Scenario 600 may pertain to prevention of an attack under the second proposed scheme. Referring to FIG. 6, an MITM may send fake data with SNs=1, 2 to a recipient B (e.g., STA 110). Upon receiving the fake data, the recipient B may send a protected BA for SNs=1, 2 to an originator A (e.g., STA 120). Upon receipt, the MITM may buffer and replay the protected BA later. Later on, the originator A may send PPDUs/MPDUs with genuine data with SNs=1, 2, 3, 4. Upon receiving the genuine data, the MITM may reply to the originator A with the replayed protected BA for SNs=1, 2. The originator A may verify the replayed protected BA and update its replay counter for the control frame protection (if not replay). The originator A may also drop the replayed protected BA because by detecting it being from an attacker by detection based on the time/signature-based protected BA being not fresh. Accordingly, under the second proposed scheme, instead of the MITM attack being detected due to header MIC check at the recipient side, the originator A may detect the MITM attack by the time/signature-based protected ACK/BA as the TSF or signature contained in the replayed protected BA does not correspond to or match information in the PPDUs/MPDUs with the genuine data.

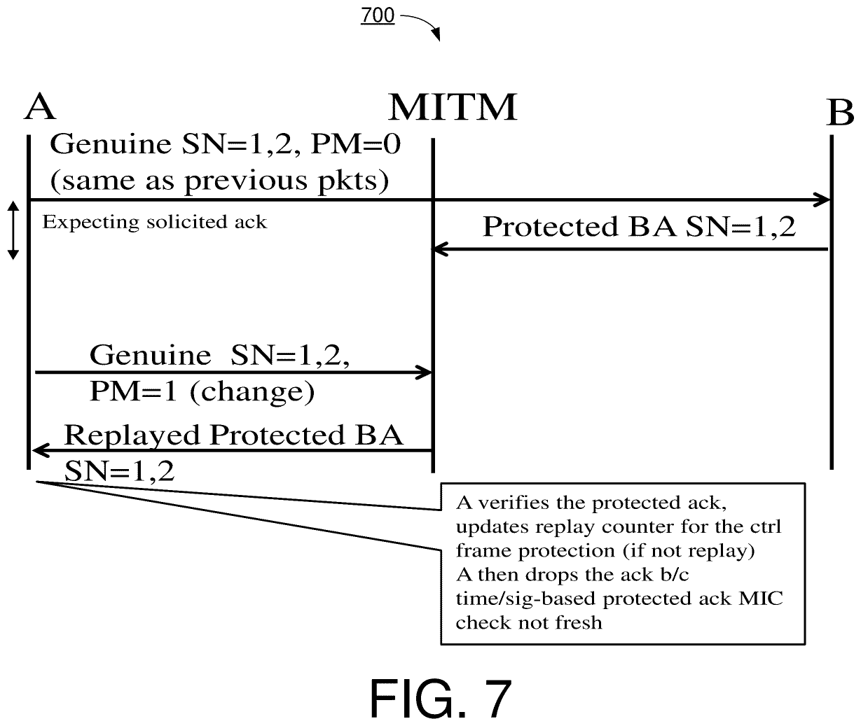

FIG. 7 illustrates an example scenario 700 in which various proposed schemes in accordance with the present disclosure may be implemented. Scenario 700 may pertain to prevention of an attack under the second proposed scheme. Referring to FIG. 7, an originator A (e.g., STA 110) may perform a transmission of genuine packets/MPDUs with SNs=1, 2 and PM=0 (with PM value same as previously transmitted/acknowledged packets). Upon receipt, a recipient B (e.g., STA 120) may send a protected BA for SNs=1, 2, which may be received by an MITM. Meanwhile, the originator A may be expecting a solicited ACK from the recipient B. Later on, due to not having received the expected solicited ACK, the originator A may retransmit the genuine packets/MPDUs for SNs=1, 2 with PM=1 (which is changed from PM=0). Upon receipt, the MITM may replay the protected BA for SNs=1, 2 previously sent by the recipient B. The originator A may verify the replayed protected BA and update its replay counter for the control frame protection (if not replay). The originator A may also drop the replayed protected BA because by detecting it being from an attacker by detection based on the time/signature-based protected BA being not fresh. Accordingly, under the second proposed scheme, although the MITM attack may not be detected by header MIC check at the recipient side, it may still be detected at the originator side by time/signature-based protected ACK/BA as the TSF or signature contained in the replayed protected BA does not correspond to or match information in the retransmitted genuine packets/MPDUs.

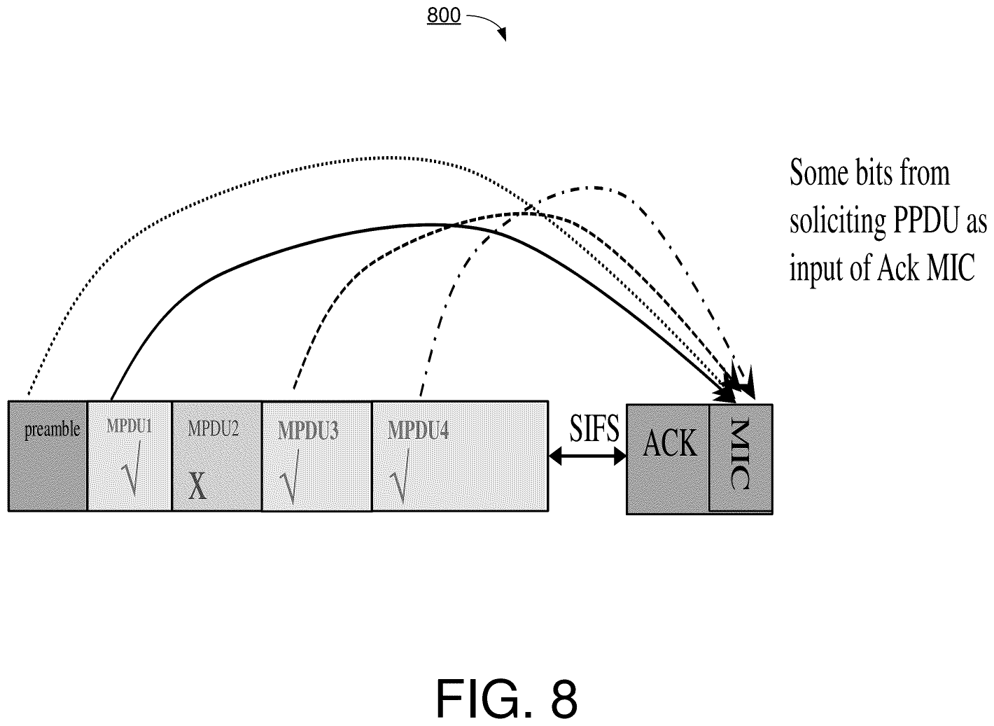

FIG. 8 illustrates an example design 800 under a proposed scheme in accordance with the present disclosure. Design 800 may pertain to a linkage between a soliciting frame and an ACK/BA. Referring to FIG. 8, inputs to ACKBA MIC (e.g., for the signature used for MITM attack detection) may include additional data which contains information of the soliciting PPDU. For instance, some bits in the soliciting MPDUs, with bit locations known by both the originator and the recipient, may be included in the MIC of an ACK/BA. This may render it difficult for attackers to selectively replace some bits while not changing other bits. Alternatively, or additionally, the header MIC and/or a number of symbols between the MIC and the ACK may be included in the MIC of the ACK/BA. This may render it difficult for attackers to send unpredictable bits (e.g., bits of header MIC) and altered bits (e.g., altered header fields) in the same symbol(s) at the correct time. Alternatively, or additionally, the soliciting PPDU length and/or one or more of the corrected received header MICs may be included in the MIC of the ACK/BA.

### Illustrative Implementations

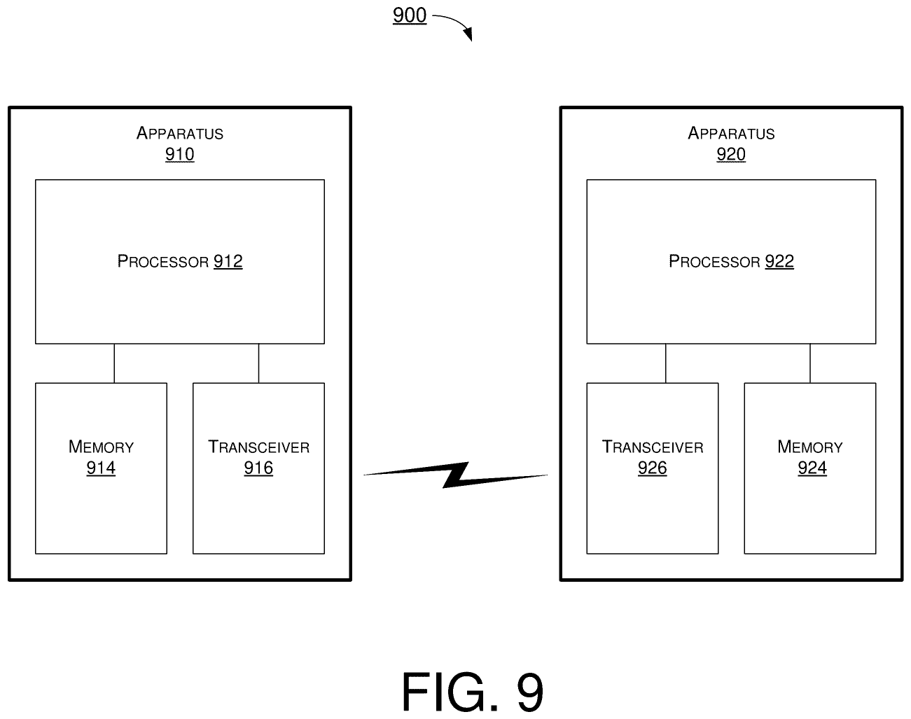

FIG. 9 illustrates an example system 900 having at least an example apparatus 910 and an example apparatus 920 in accordance with an implementation of the present disclosure. Each of apparatus 910 and apparatus 920 may perform various functions to implement schemes, techniques, processes and methods described herein pertaining to protecting the integrity of MAC header and data with relaxed receiver requirement in wireless communications, including the various schemes described above with respect to various proposed designs, concepts, schemes, systems and methods described above as well as processes described below. For instance, apparatus 910 may be implemented in STA 110 and apparatus 920 may be implemented in STA 120, or vice versa.

Each of apparatus 910 and apparatus 920 may be a part of an electronic apparatus, such as a portable or mobile apparatus, a wearable apparatus, a wireless communication apparatus or a computing apparatus. When implemented in a STA, each of apparatus 910 and apparatus 920 may be implemented in a smartphone, a smartwatch, a personal digital assistant, a digital camera, or a computing equipment such as a tablet computer, a laptop computer or a notebook computer. Each of apparatus 910 and apparatus 920 may also be a part of a machine type apparatus, which may be an IoT apparatus such as an immobile or a stationary apparatus, a home apparatus, a wire communication apparatus or a computing apparatus. For instance, each of apparatus 910 and apparatus 920 may be implemented in a smart thermostat, a smart fridge, a smart door lock, a wireless speaker or a home control center. When implemented in or as a network apparatus, apparatus 910 and/or apparatus 920 may be implemented in a network node, such as an AP in a WLAN.

In some implementations, each of apparatus 910 and apparatus 920 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 910 and apparatus 920 may be implemented in or as a controller/initiator or a controlee/responder. Each of apparatus 910 and apparatus 920 may include at least some of those components shown in FIG. 9 such as a processor 912 and a processor 922, respectively, for example. Each of apparatus 910 and apparatus 920 may further include one or more other components not pertinent to the proposed scheme of the present disclosure (e.g., internal power supply, display device and/or user interface device), and, thus, such component(s) of apparatus 910 and apparatus 920 are neither shown in FIG. 9 nor described below in the interest of simplicity and brevity.

In one aspect, each of processor 912 and processor 922 may be implemented in the form of one or more single-core processors, one or more multi-core processors, one or more RISC processors or one or more CISC processors. That is, even though a singular term “a processor” is used herein to refer to processor 912 and processor 922, each of processor 912 and processor 922 may include multiple processors in some implementations and a single processor in other implementations in accordance with the present disclosure. In another aspect, each of processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 912 and processor 922 is a special-purpose machine specifically designed, arranged and configured to perform specific tasks including those pertaining to protecting the integrity of MAC header and data with relaxed receiver requirement in wireless communications in accordance with various implementations of the present disclosure.

In some implementations, apparatus 910 may also include a transceiver 916 coupled to processor 912. Transceiver 916 may include a transmitter capable of wirelessly transmitting and a receiver capable of wirelessly receiving data. In some implementations, apparatus 920 may also include a transceiver 926 coupled to processor 922. Transceiver 926 may include a transmitter capable of wirelessly transmitting and a receiver capable of wirelessly receiving data. It is noteworthy that, although transceiver 916 and transceiver 926 are illustrated as being external to and separate from processor 912 and processor 922, respectively, in some implementations, transceiver 916 may be an integral part of processor 912 as a system on chip (SoC) and/or transceiver 926 may be an integral part of processor 922 as a SoC.

In some implementations, apparatus 910 may further include a memory 914 coupled to processor 912 and capable of being accessed by processor 912 and storing data therein. In some implementations, apparatus 920 may further include a memory 924 coupled to processor 922 and capable of being accessed by processor 922 and storing data therein. Each of memory 914 and memory 924 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 914 and memory 924 may include a type of read-only memory (ROM) such as mask ROM, programmable ROM (PROM), erasable programmable ROM (EPROM) and/or electrically erasable programmable ROM (EEPROM). Alternatively, or additionally, each of memory 914 and memory 924 may include a type of non-volatile random-access memory (NVRAM) such as flash memory, solid-state memory, ferroelectric RAM (FeRAM), magnetoresistive RAM (MRAM) and/or phase-change memory.

Each of apparatus 910 and apparatus 920 may be a communication entity capable of communicating with each other using various proposed schemes in accordance with the present disclosure. For illustrative purposes and without limitation, a description of capabilities of apparatus 910 or apparatus 920, as STA 110 and STA 120, respectively, is provided below in the context of example process 1000. It is noteworthy that, although a detailed description of capabilities, functionalities and/or technical features of either of apparatus 910 and apparatus 920 is provided below, the same may be applied to the other of apparatus 910 and apparatus 920 although a detailed description thereof is not provided solely in the interest of brevity. It is also noteworthy that, although the example implementations described below are provided in the context of WLAN, the same may be implemented in other types of networks.

### Illustrative Processes

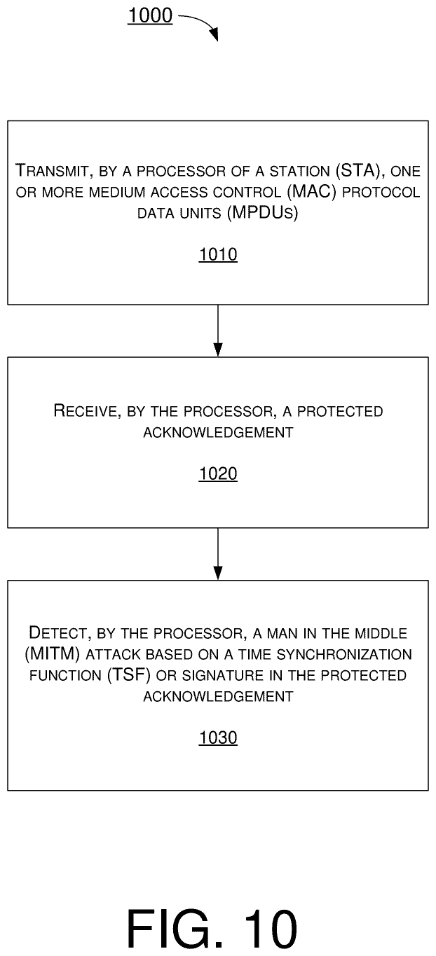

FIG. 10 illustrates an example process 1000 in accordance with an implementation of the present disclosure. Process 1000 may represent an aspect of implementing various proposed designs, concepts, schemes, systems, and methods described above. More specifically, process 1000 may represent an aspect of the proposed concepts and schemes pertaining to protecting the integrity of MAC header and data with relaxed receiver requirement in wireless communications. Process 1000 may include one or more operations, actions, or functions as illustrated by one or more of blocks/subblocks. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively, in a different order. Furthermore, one or more of the blocks/sub-blocks of process 1000 may be executed repeatedly or iteratively. Process 1000 may be implemented by or in apparatus 910 and apparatus 920 as well as any variations thereof. Solely for illustrative purposes and without limiting the scope, process 1000 is described below in the context of apparatus 910 and implemented in or as STA 110 and apparatus 920 implemented in or as STA 120 in network environment 100, or vice vera, in accordance with one or more of IEEE 802.11 standards. Process 1000 may begin at block 1010.

At 1010, process 1000 may include processor 912 of apparatus 910 transmitting, via transceiver 916, one or more MPDUs. Process 1000 may proceed from 1010 to 1020.

At 1020, process 1000 may involve processor 912 receiving, via transceiver 916, a protected acknowledgement (e.g., from an MITM attacker instead of apparatus 920 as STA 120). Process 1000 may proceed from 1020 to 1030.

At 1030, process 1000 may involve processor 912 detecting an MITM attack based on a TSF or signature in the protected acknowledgement.

In some implementations, in receiving the protected acknowledgement, process 1000 may involve processor 912 performing certain operations. For instance, process 1000 may involve processor 912 transmitting a BAR responsive to not having received a solicited acknowledgement after transmitting the one or more MPDUs. Additionally, process 1000 may involve processor 912 receiving the protected acknowledgement responsive to transmitting the BAR. In such cases, in detecting the MITM attack, process 1000 may involve processor 912 detecting the MITM attack based on the TSF or signature contained in the protected acknowledgement being not corresponding to information in the BAR.

In some implementations, in transmitting the one or more MPDUs, process 1000 may involve processor 912 transmitting the one or more MPDUs with genuine data. Moreover, in receiving the protected acknowledgement, process 1000 may involve processor 912 receiving the protected acknowledgement responsive to transmitting the one or more MPDUs with the genuine data. In such cases, in detecting the MITM attack, process 1000 may involve processor 912 detecting the MITM attack based on the TSF or signature contained in the protected acknowledgement being not corresponding to information in the one or more MPDUs with the genuine data.

In some implementations, in receiving the protected acknowledgement, process 1000 may involve processor 912 performing certain operations. For instance, process 1000 may involve processor 912 transmitting the one or more MPDUs with a PM bit set to a first value (e.g., 0). Moreover, process 1000 may involve processor 912 retransmitting the one or more MPDUs with the PM bit set to a second value (e.g., 1) different from the first value responsive to not having received a solicited acknowledgement after transmitting the one or more MPDUs. Furthermore, process 1000 may involve processor 912 receiving the protected acknowledgement responsive to retransmitting the one or more MPDUs. In such cases, in detecting the MITM attack, process 1000 may involve processor 912 detecting the MITM attack based on the TSF or signature contained in the protected acknowledgement being not corresponding to information in the retransmitted one or more MPDUs.

In some implementations, the signature may be calculated by processor 912 based on input from one or more bits of the one or more MPDUs, with location information of the one or more bits being known by both apparatus 910, as an originator, and apparatus 920, as a recipient.

In some implementations, the signature may include an MIC of a header of the one or more MPDUs.

In some implementations, the signature may include a length of the one or more MPDUs or a number of symbols between the MIC of the header of the one or more MPDUs and the acknowledgement.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of a station (STA), one or more medium access control (MAC) protocol data units (MPDUs);
receiving, by the processor, a protected acknowledgement; and
detecting, by the processor, a man in the middle (MITM) attack based on a time synchronization function (TSF) or signature in the protected acknowledgement.

2. The method of claim 1, wherein the receiving of the protected acknowledgement comprises:
transmitting a block acknowledgement request (BAR) responsive to not having received a solicited acknowledgement after transmitting the one or more MPDUs; and
receiving the protected acknowledgement responsive to transmitting the BAR.

3. The method of claim 2, wherein the detecting of the MITM attack comprises detecting the MITM attack based on the TSF or signature contained in the protected acknowledgement being not corresponding to information in the BAR.

4. The method of claim 1, wherein the transmitting of the one or more MPDUs comprises transmitting the one or more MPDUs with genuine data, and wherein the receiving of the protected acknowledgement comprises receiving the protected acknowledgement responsive to transmitting the one or more MPDUs with the genuine data.

5. The method of claim 4, wherein the detecting of the MITM attack comprises detecting the MITM attack based on the TSF or signature contained in the protected acknowledgement being not corresponding to information in the one or more MPDUs with the genuine data.

6. The method of claim 1, wherein the receiving of the protected acknowledgement comprises:
transmitting the one or more MPDUs with a power management (PM) bit set to a first value;
retransmitting the one or more MPDUs with the PM bit set to a second value different from the first value responsive to not having received a solicited acknowledgement after transmitting the one or more MPDUs; and
receiving the protected acknowledgement responsive to retransmitting the one or more MPDUs.

7. The method of claim 6, wherein the detecting of the MITM attack comprises detecting the MITM attack based on the TSF or signature contained in the protected acknowledgement being not corresponding to information in the retransmitted one or more MPDUs.

8. The method of claim 1, wherein the signature is calculated based on inputs from one or more bits of the one or more MPDUs, with location information of the one or more bits being known by both the STA, as an originator, and another STA, as a recipient.

9. The method of claim 1, wherein the signature comprises a message integrity check (MIC) of a header of the one or more MPDUs.

10. The method of claim 1, wherein the signature comprises a length of the one or more MPDUs or a number of symbols between the MIC of the header of the one or more MPDUs and the acknowledgement.

11. An apparatus implementable in a station (STA), comprising:
a transceiver configured to communicate wirelessly; and
a processor coupled to the transceiver and configured to perform operations comprising:
transmitting, via the transceiver, one or more medium access control (MAC) protocol data units (MPDUs);
receiving, via the transceiver, a protected acknowledgement; and
detecting a man in the middle (MITM) attack based on a time synchronization function (TSF) or signature in the protected acknowledgement.

12. The apparatus of claim 11, wherein the receiving of the protected acknowledgement comprises:
transmitting a block acknowledgement request (BAR) responsive to not having received a solicited acknowledgement after transmitting the one or more MPDUs; and
receiving the protected acknowledgement responsive to transmitting the BAR.

13. The apparatus of claim 12, wherein the detecting of the MITM attack comprises detecting the MITM attack based on the TSF or signature contained in the protected acknowledgement being not corresponding to information in the BAR.

14. The apparatus of claim 11, wherein the transmitting of the one or more MPDUs comprises transmitting the one or more MPDUs with genuine data, and wherein the receiving of the protected acknowledgement comprises receiving the protected acknowledgement responsive to transmitting the one or more MPDUs with the genuine data.

15. The apparatus of claim 14, wherein the detecting of the MITM attack comprises detecting the MITM attack based on the TSF or signature contained in the protected acknowledgement being not corresponding to information in the one or more MPDUs with the genuine data.

16. The apparatus of claim 11, wherein the receiving of the protected acknowledgement comprises:
transmitting the one or more MPDUs with a power management (PM) bit set to a first value;
retransmitting the one or more MPDUs with the PM bit set to a second value different from the first value responsive to not having received a solicited acknowledgement after transmitting the one or more MPDUs; and
receiving the protected acknowledgement responsive to retransmitting the one or more MPDUs.

17. The apparatus of claim 16, wherein the detecting of the MITM attack comprises detecting the MITM attack based on the TSF or signature contained in the protected acknowledgement being not corresponding to information in the retransmitted one or more MPDUs.

18. The apparatus of claim 11, wherein the signature is calculated based on inputs from one or more bits of the one or more MPDUs, with location information of the one or more bits being known by both the STA, as an originator, and another STA, as a recipient.

19. The apparatus of claim 11, wherein the signature comprises a message integrity check (MIC) of a header of the one or more MPDUs.

20. The apparatus of claim 11, wherein the signature comprises a length of the one or more MPDUs or a number of symbols between the MIC of the header of the one or more MPDUs and the acknowledgement.
